(19) United States
(12) Patent Application Publication
(10) Pub. No.: US 2016/0014010 A1
(43) Pub. Date: Jan. 14, 2016

(54) Performance Monitoring with Reduced Transmission of Information

(71) Applicant: International Business Machines Corporation, Armonk, NY (US)

(72) Inventors: Gianluca Della Corte, Rome (IT); Francesca Galeri, Rome (IT); Stefano Proietti, Rome (IT); Antonio M. Sgro, Rome (IT)

(21) Appl. No.: 14/792,950

(22) Filed: Jul. 7, 2015

(30) Foreign Application Priority Data
Jul. 8, 2014 (GB) 1412091.9

(51) Int. Cl. H04L 12/26

(52) U.S. Cl. CPC H04L 43/50; H04L 43/04

(57) ABSTRACT

A mechanism is provided for monitoring performance of a computing machine. A current indicator is collected representing a current value of a performance indicator of the computing machine. The current indicator is compared with at least one previous indicator representing a previous value of the performance indicator of the computing machine. Responsive to the current indicator being outside a threshold of the at least one previous indicator, the current indicator is transmitted remotely to a resource via a communication network. Responsive to the current indicator being within the threshold of the at least one previous indicator, the transmission of the current indicator is disabled.

### BACKGROUND

The present disclosure relates to the data processing field. More specifically, this disclosure relates to performance monitoring.

Performance monitoring of computing machines, or simply computers (i.e., the activity of observing one or more performance indicators thereof over time) plays a key role in their management. Generally, the performance monitoring activity involves the collection of one or more performance indicators on each computer (for example, by measuring different types of metrics relating to the status of monitored resources of the computing machine, such as processing power consumption and software application usage). These performance indicators provide valuable information about the condition of the computers. For example, this allows detecting any problem that may be experienced by the computers (so that appropriate actions may be taken to remedy the situation). Moreover, the performance indicators may be logged and/or analyzed for different purposes; for example, this information may be used for capacity planning, charge-back accounting, service level verification, availability watching.

Particularly, in distributed computing systems (wherein the computers exploit services offered by other computers over a network) the performance indicators may be collected on end-point computers and then transmitted remotely to a central computer for their processing. A typical example is in a cloud computing (or simply cloud) infrastructure, wherein users of the network are allowed to access computing resources on-demand as services (referred to as cloud resources and cloud services, respectively); the cloud services are made available by cloud providers, which provision, configure and release the cloud resources upon request (so that their actual implementation is completely opaque to the users). In this way, the users are relived of the management of the actual physical resources that are needed to implement the cloud resources (for example, their installation and maintenance); particularly, this provides economies of scale, improved exploitation of the physical resources, and high peak-load capacity. Moreover, the users are now allowed to perform tasks (on a pay-per-use basis) that were not feasible previously because of their cost and complexity (especially for individuals or small companies). The de-coupling of the cloud resources from their implementation provides the illusion of an infinite capacity thereof; moreover, the de-localization of the physical resources implementing the cloud resources enables the users to access them from anywhere.

In this case, the performance monitoring may be implemented as a Software-as-a-Service (SaaS), wherein a monitoring software application is supplied on-demand by the cloud providers. For example, US-A-2012/0246297 (the entire disclosure of which is herein incorporated by reference) describes an agent based monitoring SaaS, wherein proxy clients installed on network equipment devices belonging to a customer discover network equipment devices on a private network of the customer, transmit information identifying the discovered devices to a server and monitor the network equipment device(s) according to monitoring definition(s) configured by the customer.

Generally, the performance indicators are collected at relatively high frequency (for example, every few seconds-minutes); this maintains an up-to-date overview of the monitored computers (in quasi real-time), so as to allow intervening timely when it is necessary.

However, in distributed computing systems this requires the continual transmission of the performance indicators from the end-point computers to the central computer; this increases a traffic of the network and a workload of the central computer (with a risk of congestions thereof).

Particularly, when the performance monitoring is implemented as a SaaS the users are generally billed according to the amount of information that is processed by the cloud providers; therefore, the higher the frequency of the transmission of the performance indicators the higher the cost of the performance monitoring activity for the users.

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In general terms, the present disclosure is based on the idea of reducing the transmission of information.

In one illustrative embodiment, a method, in a data processing system, is provided for monitoring performance of a computing machine. The illustrative embodiment collects a current indicator representing a current value of a performance indicator of the computing machine. The illustrative embodiment compares the current indicator with at least one previous indicator representing a previous value of the performance indicator of the computing machine. The illustrative embodiment transmits the current indicator remotely to a resource via a communication network in response to the current indicator being outside a threshold of the at least one previous indicator. The illustrative embodiment disables the transmission of the current indicator in response to the current indicator being within the threshold of the at least one previous indicator.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes—such as value, content and representation). Particularly:

FIG. 1 shows a schematic block-diagram of a computing system wherein the solution according to an embodiment of the present disclosure may be practiced,

FIG. 2A-FIG. 2D show an exemplary application of the solution according to an embodiment of the present disclosure,

FIG. 3 shows the main software components that may be used to implement the solution according to an embodiment of the present disclosure, and

FIG. 4A-FIG. 4B show an activity diagram describing the flow of activities relating to an implementation of the solution according to an embodiment of the present disclosure.

### DETAILED DESCRIPTION

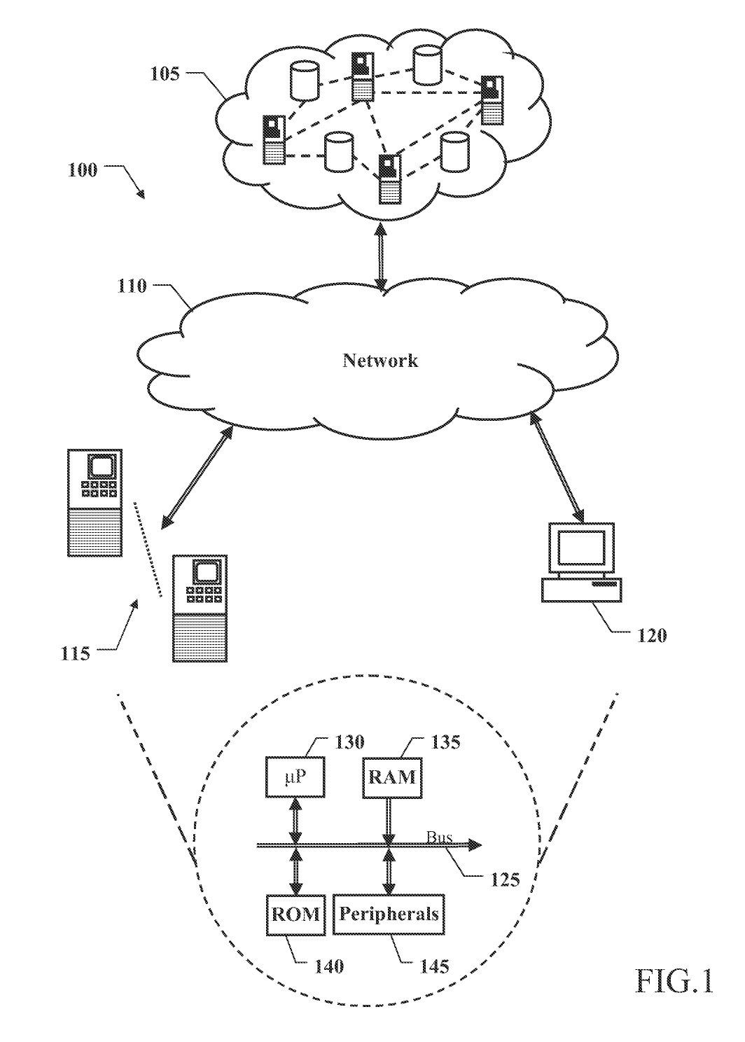

With reference in particular to FIG. 1, a schematic block-diagram is shown of a computing system 100 wherein the solution according to an embodiment of the present disclosure may be practiced.

Particularly, the computing system 100 is a cloud (computing) infrastructure that comprises one or more cloud providers 105 (only one shown in the figure). Each cloud provider 105 is an entity that makes available a pool of cloud resources on-demand (i.e., shared computing resources that may be provisioned, configured and released very rapidly); these cloud resources are generally of the virtual type (i.e., emulations by software of physical resources). Each user of the cloud provider 105 has the sole control of the corresponding cloud resources, which may then be used exactly as if they were dedicated physical resources.

The cloud provider 105 has a front-end component that is exposed to its users for accessing the desired cloud resources through a communication network 110. For example, the cloud-computing infrastructure 100 is public, wherein the cloud provider 105 is implemented by a third party that bills the users on a pay-per-use basis, and it is accessed through the Internet.

The cloud resources are actually implemented by a back-end component of the cloud provider 105; typically, the back-end component of the cloud provider 105 comprises a pool of physical computing machines and storage devices being loosely coupled to each other, with a redundant architecture to ensure the required reliability level. The back-end component of the cloud provider 105 is not accessible from the outside, so that the users are completely agnostic about the actual location and configuration thereof.

In the context of the present disclosure, the cloud resources offered by the cloud provider 105 comprise SaaS facilities, and particularly a performance monitoring application that is supplied as a service on-demand. In this case, a generic user of the cloud provider 105 may monitor selected resources of one or more computing machines thereof, for example, server computing machines (or simply servers) 115; the monitored resources may be of different type, for example, hardware and/or software computing resources (such as processing power, working memory, operating system, application programs). The user may access the performance monitoring application (for example, for configuring and reporting purposes) by one or more client computing machines (or simply clients) 120 (only one shown in the figure), each client 120 may be of the thin type (such as a netbook, a tablet computer or a smartphone), since the required computational and storage capabilities are offered by the cloud provider 105.

A generic computing machine of the cloud infrastructure 100, i.e., of the user (server 115 or client 120) or of the cloud provider 105, comprises several units that are connected in parallel to a bus structure 125 (with an architecture that is suitably scaled according to the actual function of the computing machine in the cloud infrastructure 100). In detail, one or more microprocessors (μP) 130 control operation of the computing machine; a RAM 135 is used as a working memory by the microprocessors 130, and a ROM 140 stores basic code for a bootstrap of the computing machine. The computing machine is also provided with one or more peripherals 145, which are specific for its function in the cloud infrastructure 100 (for example, a mass memory such as one or more hard-disks, drives for reading/writing removable storage units such as optical disks, a keyboard, a mouse, a monitor, a network adapter).

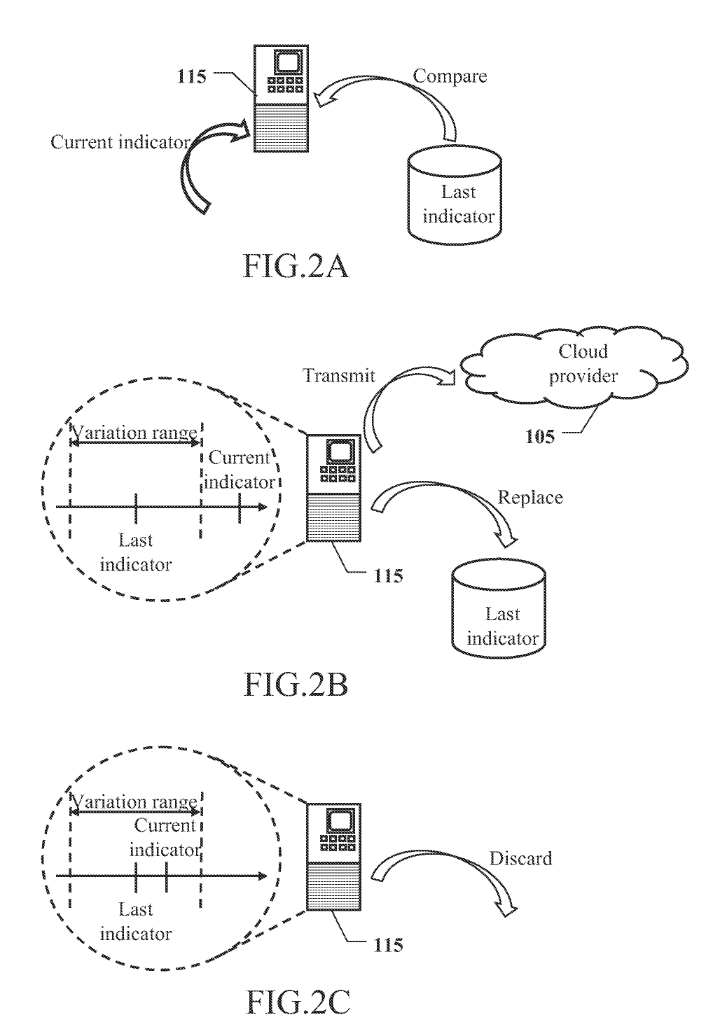

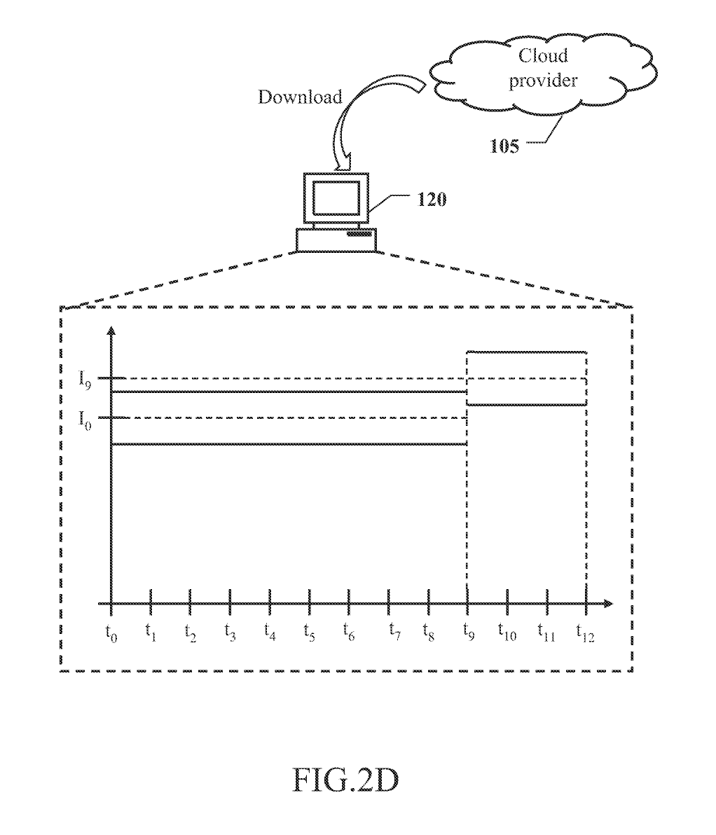

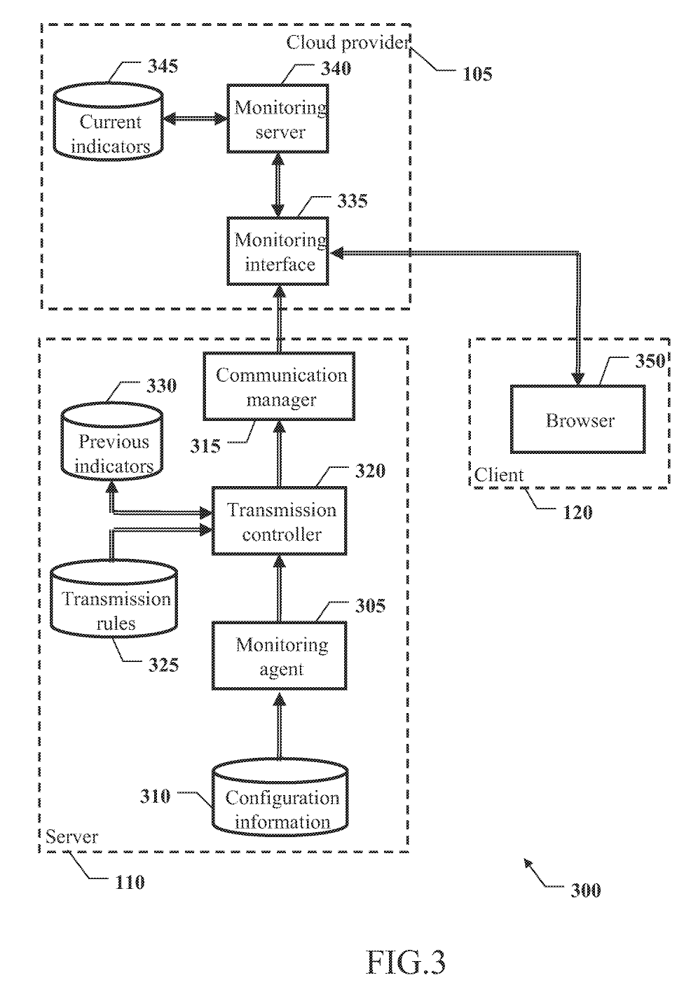

With reference now to FIG. 2A-FIG. 2D, an exemplary application is shown of the solution according to an embodiment of the present disclosure.

Starting from FIG. 2A, a generic server 115 repeatedly collects (for example, periodically) a current value of one or more performance indicators (or simply current indicators), which represent the status of corresponding monitored resources over time; for example, the performance indicators may be collected by measuring selected metrics of the monitored resources, which may indicate consumption of hardware resources (such as percentage) or usage of software resources (such as processed transactions per seconds).

Each current indicator is then compared with one or more previous values of the same performance indicator; for example, the current indicator may be compared with a last value of the performance indicator that was transmitted to the cloud provider, not shown in the figure (or simply last indicator). The transmission of the current indicator to the cloud provider is then enabled or disabled according to the result of this comparison.

For example, as shown in FIG. 2B, the current indicator is compared with a variation range centered on the last indicator (as defined by a variation threshold that represents a significant variation thereof in absolute value). When the current indicator is outside the variation range (meaning that it varied significantly with respect to the last indicator), the current indicator is transmitted from the server 115 to the cloud provider 105 as usual (and it replaces the last indicator on the server 115).

Conversely, as shown in FIG. 2C, when the current indicator is inside the variation range (meaning that it did not vary significantly, i.e., it remained in the neighborhood of the last indicator), the current indicator is discarded (without its transmission to the cloud provider 105).

As a result, the transmission of the performance indicators remotely (i.e., from the server 115 to the cloud provider 105 in the example at issue) is significantly limited; this reduces a traffic of the corresponding network and a workload of each computing machine that is dedicated to process them (i.e., the ones of the cloud provider 105 in the example at issue), and then any risk of congestions thereof.

This is particularly advantageous when the performance monitoring is implemented as a SaaS. Indeed, in this case the users are generally billed according to the amount of information that is processed by the cloud provider 105; therefore, the lower frequency of the transmission of the performance indicators involves a lower cost of the performance monitoring activity for the users.

The above-mentioned results are achieved without substantially affecting the accuracy of the performance monitoring activity; this allows maintaining an up-to-date overview of the computing machines under monitoring (in quasi real-time), and then intervening timely when it is necessary. Indeed, the values of the performance indicators that are discarded have a relatively low significance, so that the corresponding loss of information may be deemed negligible in most practical situations.

For example, as shown in FIG. 2D, a monitoring report is downloaded from the cloud provider 105 onto a generic client 120. The monitoring report provides a graphical representation of the monitoring activity that is in progress in a corresponding diagram (for example, displayed on the monitor of the client 120), which plots the values of the performance indicator (on the ordinate axis) against the time (on the abscissa axis).

Particularly, the current indicators that are collected in succession at the instants t₀-t₁₂ (for example, every 5 minutes for the processing power consumption in percentage) may be:

I₀=19.1%, I₂=19.2%, I₃=19.5%, I₄=18.6%, I₅=17.9%, I₆=18.5%, I₇=19.1%, I₈=19.3%, I₉=22.3%, I₁₀=22.7%, I₁₁=21.8%, I₁₂=22.1%.
If the variation range of the current indicators I₀-I₁₂ is defined by a variation threshold of ±2.0%, after the transmission of the first current indicator I₀=19.1% only the current indicator I₉=22.3% is transmitted to the cloud provider 105 (since it is outside the corresponding variation range, from 19.1−2.0=17.1% to 19.1+2.0=21.1%); therefore, in one hour (from the instant I₀ to the instant I₉) this simply requires the transmission of 2 current indicators to the cloud provider 105 (instead of 13).

In this case, the monitoring report (instead of displaying a line representing the actual current indicators I₀-I₁₂ at each instant t₀-t₁₂) now displays a bar that is centered on each current indicator I₀-I₁₂ that has been transmitted to the cloud provider 105, or simply transmitted indicator, with a width representing the variation range (i.e., above and below it by the variation threshold). This informs the user that (apart from the instants I₀ and I₁₁ at which the actual current indicators I₀ and I₉, respectively, are known) at all the other instants the corresponding current indicators are not known exactly, but in any case they belong to the corresponding variation range.

In this case as well, the downloading of the values of the performance indicators (from the cloud provider 105 onto the client 120) is significantly limited, since it only relates to the transmitted indicators; as above, this reduces a traffic of the corresponding network and a workload of the cloud provider 105 (and then any risk of congestions thereof), and particularly the cost of the performance monitoring activity for the users.

With reference now to FIG. 3, the main software components are shown that may be used to implement the solution according to an embodiment of the present disclosure. Particularly, the software components (programs and data) are denoted as a whole with the reference 300. The software components 300 are typically stored in the mass memory and loaded (at least partially) into the working memory of each computing machine when the programs are running, together with an operating system and other application programs (not shown in the figure). The programs are initially installed into the mass memory, for example, from removable storage units or from the Internet. In this respect, each software component may represent a module, segment or portion of code, which comprises one or more executable instructions for implementing the specified logical function.

Particularly, a generic server 110 runs a monitoring agent 305 for monitoring selected resources thereof. For this purpose, the monitoring agent 305 accesses a configuration information repository 310 that stores configuration information for controlling the performance monitoring activity (for example, an indication of the monitored resources, a (specific or common) monitoring frequency for their monitoring, the performance indicator and measuring instructions for collecting it for each monitored resource). The monitoring agent 305 collects the current indicators (for the monitored resources) and passes them to a communication manager 315.

In the solution according to an embodiment of the present disclosure, a transmission controller 320 is interposed between the monitoring agent 305 and the communication manager 315; the transmission controller 320 discards or relays the current indicators as mentioned above. For this purpose, the transmission controller 320 accesses a transmission rule repository 325, which stores transmission rules for controlling the transmission of the current indicators; for example, for each performance indicator the corresponding transmission rule stores its variation threshold (for defining the variation range of the performance indicator) and an alarm threshold (for detecting an alarm condition of the performance indicator). Moreover, the transmission controller 320 manages a previous indicator repository 330, which saves one or more previous indicators to be compared with each current indicator (for example, the corresponding last indicator).

Moving to the cloud provider 105, it exposes a monitoring interface 335 that is used to access the performance monitoring application supplied by it as a SaaS. Particularly, the monitoring interface 335 receives all the current indicators that are transmitted thereto by the communication manager 315 of each server 110. The monitoring interface 335 cooperates with a monitoring server 340, which processes the received current indicators of each monitored resource; for this purpose, the current indicators of each monitored resource (for each user) are saved into a current indicator repository 345.

A generic client 120 instead runs a browser 350, which is normally used to surf the Internet. Particularly, in this case the browser 350 is used to access the monitoring interface 335 to manage each performance monitoring activity (for example, to create, update, delete, start, stop it, and to download corresponding monitoring reports).

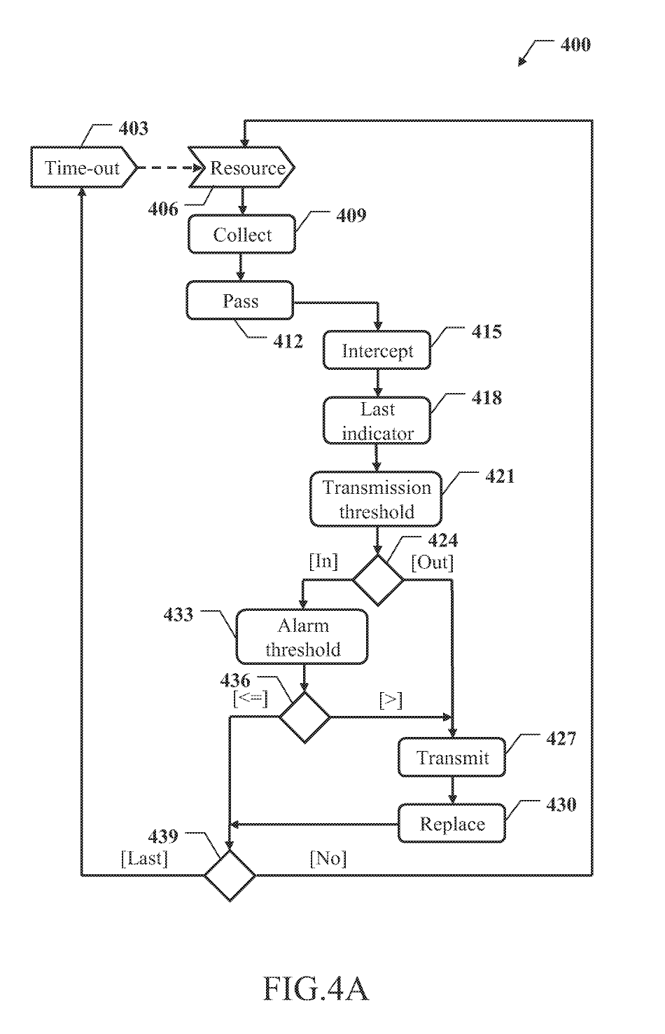

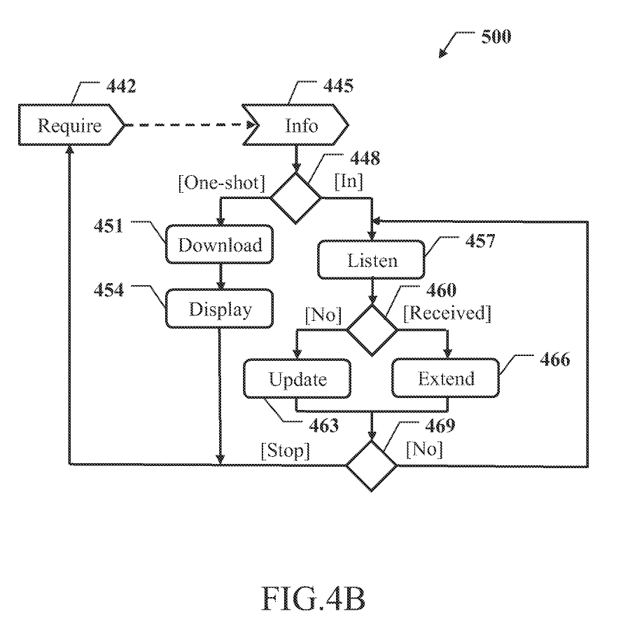

With reference now to FIG. 4A-FIG. 4B, an activity diagram is shown describing the flow of activities relating to an implementation of the solution according to an embodiment of the present disclosure. Particularly, the activity diagram represents an exemplary process that may be used to implement a performance monitoring activity with methods 400 and 500. In this respect, each block may represent one or more executable instructions for implementing the specified logical function on the mobile device.

Particularly, the monitoring agent of each server (only one taken into account for the sake of simplicity) operates in a push-mode, wherein it periodically collects the current indicators for its monitored resources. For this purpose, in method 400, the flow of activity enters block 403 whenever a monitoring time-out expires (corresponding to the monitoring frequency indicated in the configuration information repository, considered the same for all the monitored resources for the sake of simplicity). In response thereto, a loop is performed for processing the monitored resources (as indicated in the configuration information repository).

The loop begins at block 406, wherein the monitored resources are scanned in succession (starting from the first one); in this phase, the performance indicator and the measuring instructions for the (current) monitored resource are retrieved (from the configuration information repository). The current indicator is then collected at block 409 by executing these measuring instructions. Continuing to block 412, the current indicator is passed (from the monitoring agent to the communication manager) for its transmission to the cloud provider.

The current indicator is intercepted at block 415 (by the transmission controller); for example, this result may be achieved by exploiting hooking techniques (wherein the transmission controller is listening on a corresponding communication channel). In this way, the above-described technique may be readily applied to standard monitoring agents (without requiring any change thereof), so that it is of general applicability in a fast and simple way. In response thereto, the last indicator is retrieved at block 418 (from the previous indicator repository), with the last indicator that is initialized to a null value always causing the transmission of the current indicator at the beginning of the performance monitoring activity. Continuing to block 421, the transmission threshold of the monitored resource is retrieved as well (from the transmission rule repository, with this operation that may be performed only once at the beginning of the performance monitoring activity). The current indicator is then compared at block 424 with the transmission range defined by the transmission threshold around the last indicator.

If the current indicator is outside the transmission range (i.e., the absolute value of the difference between the current indicator and the last indicator is, possibly strictly, higher than the transmission threshold), the current indicator is transmitted to the cloud provider at block 427. Continuing to block 430, the current indicator replaces the last indicator for the monitored resource (in the previous indicator repository).

Instead, if the current indicator is inside the transmission range (i.e., the absolute value of the difference between the current indicator and the last indicator is, possibly strictly, lower than the transmission threshold), the flow of activity descends from the block 424 into block 433; in this phase, the alarm threshold for the monitored resource is retrieved (from the transmission rule repository, with this operation as well that may be performed only once at the beginning of the performance monitoring activity). The current indicator is then compared at block 436 with the alarm threshold. If the current indicator is (possibly strictly) higher than the alarm threshold, the flow of activity continues to the block 427 as above (so as to transmit the current indicator to the cloud provider). In this way, the current indicator is always transmitted to the cloud provided (irrespectively of its comparison with the last indicator) in case of an alarm condition, so as to avoid any loss thereof. Conversely, if the current indicator is (possibly strictly) lower than the alarm threshold, the flow of activity descends from the block 436 into block 439, which point is also reached from the block 430. A test is now made to verify whether all the monitored resources have been processed. If not, the flow of activity returns to the block 406 to repeat the same operations for a next monitored resource. Conversely, after a last monitored resource has been processed the flow of activity returns to the block 403 waiting for a next expire of the monitoring time-out.

In a completely independent way, in method 500, block 442 is entered on each client whenever the user requires a monitoring report for one or more monitored resources of one or more servers (only one taken into account for the sake of simplicity), for example, by submitting a corresponding command or simply opening a monitoring console. In response thereto, the client at block 445 receives the corresponding monitoring frequency and transmission threshold (from the cloud provider). The flow of activity then branches at block 448 according to the type of monitoring report that has been requested; particularly, blocks 451-454 are executed when the user has requested a (one-shot) monitoring report relating to a specific period, whereas blocks 457-469 are executed when the user has requested a (continual) monitoring report involving an automatic refresh over time.

With reference in particular to block 451 (one-shot monitoring report), all the transmitted indicators which are available in this period are downloaded at block 451 (from the cloud provider). Continuing to block 454, the monitoring report is created and displayed (on the monitor of the client) by adding each transmitted indicator and a bar centered on it, according to the transmission threshold, extending up to a next transmitted indicator. The flow of activity then returns to the block 442 waiting for a next request.

With reference instead to block 457 (continual monitoring report), the client is listening for a (new) transmitted indicator (downloaded from the cloud provider as soon as available). The flow of activity descends into block 460 when a transmitted indicator is received, or in any case after a refresh time-out (for example, corresponding to the monitoring frequency) has expired. If the transmitted indicator has been received, the monitoring report is updated and displayed at block 463, by adding it and then starting a new bar, centered on the transmitted indicator according to the transmission threshold. Conversely, the bar (of the last transmitted indicator) is extended and displayed at block 466 according to the elapsed time (from its previous update). In both cases, the flow of activity merges again at block 469, wherein a test is made to verify whether a stop command for the refresh of the monitoring report has been submitted. If not, the flow of activity returns to the block 457 listening for a next transmitted indicator. Conversely, the flow of activity returns to the block 442 waiting for a next request.

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may even be practiced without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. In any case, ordinal or other qualifiers are merely used as labels to distinguish elements with the same name but do not by themselves connote any priority, precedence or order. Moreover, the terms include, comprise, have, contain and involve (and any forms thereof) should be intended with an open, non-exhaustive meaning (i.e., not limited to the recited items), the terms based on, dependent on, according to, function of (and any forms thereof) should be intended as a non-exclusive relationship (i.e., with possible further variables involved), the term a/an should be intended as one or more items (unless expressly indicated otherwise), and the term means for (or any means-plus-function formulation) should be intended as any entity or structure suitable for carrying out the relevant function.

For example, an embodiment provides a method for monitoring performance of a computing machine. The method comprises the repetition of the following steps. A current indicator (representing a current value of a performance indicator of the computing machine) is collected. The current indicator is transmitted remotely. The transmission of the current indicator is disabled according to a comparison of the current indicator with at least one previous indicator (representing a previous value of the performance indicator).

However, the computing machine may be of any type and the above-mentioned steps may be repeated in any way (see below). The performance indicator may be of any type; for example, the performance indicator may relate to any type of resource (such as hardware resources like a network or software resource like utilities), or more generally to any other aspect of the computing machine (such as its response time); likewise, the performance indicator may be expressed by any value (for example, in absolute or relative terms). The current indicator may be collected in any may (for example, by reading registers or querying external peripherals), and it may also be obtained by combining two or more indexes in any way (for example, by averaging them). The current indicator may be transmitted remotely in any way (for example, over a LAN). The transmission of the current indicator may be disabled in any way according to any comparison with any previous indicators (see below).

In an embodiment, said disabling the transmission of the current indicator comprises disabling the transmission of the current indicator according to a comparison of the current indicator with a last indicator representing a last value of the performance indicator being transmitted remotely.

However, the possibility of basing the comparison on two or more previous indicators is feasible (for example, according to their average).

In an embodiment, said disabling the transmission of the current indicator comprises disabling the transmission of the current indicator according to an inclusion of the current indicator in a variation range comprising the last indicator.

However, the variation range may be defined in any way (see below). In any case, the current indicator may be compared with the last indicator (or more generally with one or more previous indicators) in any way; for example, it is possible to prevent the transmission only after the current indicator remains included in the transmission range for two or more consecutive times.

In an embodiment, the variation range is centered on the last indicator.

However, the variation range may be defined in any way (for example, in either relative or absolute terms); in any case, the transmission range may be asymmetric, or even completely above or below the last indicator.

In an embodiment, the method further comprises the following steps. An indication is received of each transmitted current indicator in a monitoring interval, which comprises a plurality of monitoring instants each one associated with the collection of a corresponding current indicator. A monitoring report is displayed; for each monitoring instant, the monitoring report comprises a representation of the corresponding transmitted current indicator when available or a representation of the variation range for a last available transmitted current indicator otherwise.

However, the monitoring interval may be defined in any way (for example, up to the occurrence of a specific condition). The monitoring report may be displayed in any way (for example, by printing it), and it may have any format (see below). In any case, the transmitted current indicators may be used for different, additional or alternative purposes (for example, their analysis for capacity planning, charge-back accounting, service level verification).

In an embodiment, said displaying a monitoring report comprises displaying a representation of a bar for each monitoring instant at which the corresponding transmitted current indicator is available; the bar has a width corresponding to the variation range of the transmitted current indicator.

However, the monitoring report may have any other format; for example, at each monitoring instant it may comprise the corresponding transmitted current indicator when available or a segment representing the variation range around the last transmitted current indicator otherwise.

In an embodiment, the method further comprises enabling the transmission of the current indicator irrespectively of the comparison between the current indicator and said at least one previous indicator according to a comparison of the current value with an alarm threshold.

However, the alarm threshold may be defined in any way (for example, in either absolute or relative terms); moreover, the transmission of the current indicator may be enabled according to any comparison with the alarm threshold (for example, only after the same condition remains for two or more consecutive times). In any case, this feature may also be omitted in a basic implementation.

In an embodiment, said collecting a current indicator comprises collecting the current indicator periodically.

However, the current indicators may be collected with any frequency; in any case, the collection of the current indicators may be performed in different ways (for example, in response to a polling request or asynchronously as soon as they are available).

In an embodiment, said disabling the transmission of the current indicator comprises intercepting the transmission of the current indicator, and discarding or relaying the current indicator according to the comparison of the current indicator with said at least one previous indicator.

However, the same result may also be achieved by wrapping the monitoring agent, or even with a custom version thereof.

In an embodiment, said transmitting the current indicator remotely comprises transmitting the current indicator to a cloud provider supplying a monitoring application as a service.

However, the same technique may be applied to any type of cloud infrastructure (for example, of the private or hybrid type). In any case, its application is not excluded to any other (distributed) computing systems (for example, in a classic client/server environment).

Generally, similar considerations apply if the same solution is implemented with an equivalent method (by using similar steps with the same functions of more steps or portions thereof, removing some steps being non-essential, or adding further optional steps); moreover, the steps may be performed in a different order, concurrently or in an interleaved way (at least in part).

A further embodiment provides a computer program, which is configured for causing a computing system to perform the above-mentioned method when the computer program is executed on the computing system. A further embodiment provides a computer program product, which comprises a non-transitory computer readable medium embodying a computer program; the computer program is loadable into a working memory of a computing system thereby configuring the computing system to perform the same method.

However, the computer program may be implemented as a stand-alone module, as a plug-in for a monitoring application, or even directly in the latter. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in base-band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the relevant computer, as a stand-alone software package, partly on this computer and partly on a remote computer or entirely on the remote computer. In the latter scenario, the remote computer may be connected to the computer through any type of network, including a local area network (LAN) or a wide area network (WAN), or the connection may be made to an external computer (for example, through the Internet using an Internet Service Provider). Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A further embodiment provides a system, which comprises means configured for performing the steps of the above-mentioned method.

However, the system may be of any type (for example, a client like a netbook, tablet or smartphone).

Generally, similar considerations apply if the system has a different structure or comprises equivalent components, or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

1. A method, in a data processing system, for monitoring performance of a computing machine, the method comprising the repetition of:
collecting, by a processor in the data processing system, a current indicator representing a current value of a performance indicator of the computing machine;
comparing, by the processor, the current indicator with at least one previous indicator representing a previous value of the performance indicator of the computing machine;
responsive to the current indicator being outside a threshold of the at least one previous indicator, transmitting, by the processor, the current indicator remotely to a resource via a communication network; and
responsive to the current indicator being within the threshold of the at least one previous indicator, disabling, by the processor, the transmission of the current indicator.

2. The method according to claim 1, wherein the disabling of the transmission of the current indicator comprises:
disabling, by the processor, the transmission of the current indicator according to a comparison of the current indicator with a last indicator representing a last value of the performance indicator transmitted remotely to the resource in the cloud environment via the communication network.

3. The method according to claim 2, wherein
the threshold is a variation range comprising the last indicator.

4. The method according to claim 3, wherein the variation range is centered on the last indicator.

5. The method according to claim 1, further comprising:
receiving, by the processor, an indication of each transmitted current indicator in a monitoring interval comprising a plurality of monitoring instants each one associated with the collection of a corresponding current indicator, and
displaying, by the processor, a monitoring report, for each monitoring instant the monitoring report comprising a representation of the corresponding transmitted current indicator when available or a representation of a variation range for a last available transmitted current indicator otherwise.

6. The method according to claim 5, wherein the displaying of the monitoring report comprises:
displaying, by the processor, a representation of a bar for each monitoring instant at which the corresponding transmitted current indicator is available, the bar having a width corresponding to the variation range of the transmitted current indicator.

7. The method according to claim 1, further comprising:
enabling, by the processor, the transmission of the current indicator irrespective of the comparison between the current indicator and the at least one previous indicator according to a comparison of the current indicator with an alarm threshold.

8. The method according to claim 1, wherein the collecting of the current indicator comprises:
collecting, by the processor, the current indicator periodically.

9. The method according to claim 1, wherein the disabling of the transmission of the current indicator comprises:
intercepting, by the processor, the transmission of the current indicator within the computing machine, and
discarding or relaying, by the processor, the current indicator responsive to the current indicator being within the threshold of the at least one previous indicator.

10. The method according to claim 1, wherein
the resource is a monitoring application as a service in a cloud provider.

11. A computer program product comprising a computer readable storage medium having a computer readable program stored therein, wherein the computer readable program, when executed on the computing system, causes the computing system to:
collect a current indicator representing a current value of a performance indicator of the computing machine;
compare the current indicator with at least one previous indicator representing a previous value of the performance indicator of the computing machine;
responsive to the current indicator being outside a threshold of the at least one previous indicator, transmit the current indicator remotely to a resource via a communication network; and
responsive to the current indicator being within the threshold of the at least one previous indicator, disable the transmission of the current indicator.

12. A system comprising:
a processor; and
a memory coupled to the processor, wherein the memory comprises instructions which, when executed by the processor, cause the processor to:
collect a current indicator representing a current value of a performance indicator of the computing machine;
compare the current indicator with at least one previous indicator representing a previous value of the performance indicator of the computing machine;
responsive to the current indicator being outside a threshold of the at least one previous indicator, transmit the current indicator remotely to a resource via a communication network; and
responsive to the current indicator being within the threshold of the at least one previous indicator, disable the transmission of the current indicator.

13. The system according to claim 12, wherein the instructions to disable the transmission of the current indicator comprises instructions that cause the processor to:
disable the transmission of the current indicator according to a comparison of the current indicator with a last indicator representing a last value of the performance indicator transmitted remotely to the resource in the cloud environment via the communication network.

14. The system according to claim 12, wherein the instructions further cause the processor to:
receive an indication of each transmitted current indicator in a monitoring interval comprising a plurality of monitoring instants each one associated with the collection of a corresponding current indicator, and
display a monitoring report, for each monitoring instant the monitoring report comprising a representation of the corresponding transmitted current indicator when available or a representation of a variation range for a last available transmitted current indicator otherwise.

15. The system according to claim 14, wherein the instruction to display the monitoring report comprises instructions that cause the processor to:
display a representation of a bar for each monitoring instant at which the corresponding transmitted current indicator is available, the bar having a width corresponding to the variation range of the transmitted current indicator.

16. The system according to claim 12, wherein the instructions further cause the processor to:
enable the transmission of the current indicator irrespective of the comparison between the current indicator and the at least one previous indicator according to a comparison of the current indicator with an alarm threshold.

17. The computer program product according to claim 11, wherein the computer readable program to disable the transmission of the current indicator comprises computer readable program that causes the computing system to:
disable the transmission of the current indicator according to a comparison of the current indicator with a last indicator representing a last value of the performance indicator transmitted remotely to the resource in the cloud environment via the communication network.

18. The computer program product according to claim 11, wherein the computer readable program further causes the computing system to:
receive an indication of each transmitted current indicator in a monitoring interval comprising a plurality of monitoring instants each one associated with the collection of a corresponding current indicator, and
display a monitoring report, for each monitoring instant the monitoring report comprising a representation of the corresponding transmitted current indicator when available or a representation of a variation range for a last available transmitted current indicator otherwise.

19. The computer program product according to claim 18, wherein the computer readable program to display the monitoring report comprises computer readable program that causes the computing system to:
display a representation of a bar for each monitoring instant at which the corresponding transmitted current indicator is available, the bar having a width corresponding to the variation range of the transmitted current indicator.

20. The computer program product according to claim 11, wherein the computer readable program further causes the computing system to:
enable the transmission of the current indicator irrespective of the comparison between the current indicator and the at least one previous indicator according to a comparison of the current indicator with an alarm threshold.
